(19) United States
(12) Patent Application Publication
(10) Pub. No.: US 2006/0029286 A1
(43) Pub. Date: Feb. 9, 2006

(54) Image processing method

(76) Inventors: Jung-Taek Lim, Suwon-si (KR); Hyo-Cheon Kang, Suwon-si (KR); Chung-Sam Jun, Suwon-si (KR); Dong-Chun Lee, Hwaseong-si (KR); Byoung-Ho Lee, Hwaseong-si (KR)

Correspondence Address: VOLENTINE FRANCOS, & WHITT PLLC, ONE FREEDOM SQUARE, 11951 FREEDOM DRIVE SUITE 1260, RESTON, VA, 20190, US

(21) Appl. No.: 11/198,314

(22) Filed: Aug. 8, 2005

(30) Foreign Application Priority Data
Aug. 9, 2004 (KR) 2004-62307

(51) Int. Cl. G06K 9/40

(52) U.S. Cl. 382/260

(57) ABSTRACT

An image processing method is disclosed. The method comprises capturing a plurality of images of a sample using a scanning electron microscope (SEM). The method further comprising computing a mean value for each pixel location in the plurality of images and forming an integrated image with the mean values. The method further comprises filtering the integrated image using a median filter.

### BACKGROUND OF THE INVENTION

1. Field of the Invention

The present invention relates generally to a method of processing an image. More particularly, the present invention relates to a method of processing an image produced by a scanning electron microscope (SEM) in order to remove noise.

A claim of priority is made to Korean Patent Application No. 2004-62307, filed on Aug. 9, 2004, the disclosure of which is hereby incorporated by reference in its entirety.

2. Description of the Related Art

The performance of modern semiconductor devices is determined, at least in part, by the size and density of processing elements formed on the devices. For example, semiconductor devices with smaller, more densely formed processing elements generally achieve higher performance (e.g., throughput, data access speed, clock rate, etc.) than semiconductor devices having larger, less densely formed processing elements.

High performance modern semiconductor devices are typically manufactured through a large number of processing steps. The processing steps may include, for example, various photographic and/or chemical processes including doping processes, thermal oxidation processes, chemical vapor deposition (CVD) processes, etching processes, photographic exposure processes, and so forth. These processes are used to form various processing elements and thin patterns on a semiconductor substrate or a glass substrate.

The processing elements and patterns are typically inspected to ensure that they are properly formed. As the size of the processing elements decreases and the density of the processing elements increases, the patterns often need to be inspected a large number of times. Unfortunately, pattern inspections tend to significantly increase the amount of time required to manufacture a semiconductor device.

A conventional method of inspecting patterns or processing elements formed on a semiconductor substrate uses a scanning electron microscope (SEM). The SEM irradiates electrons onto a semiconductor substrate to cause secondary electrons to be emitted from the semiconductor substrate. The secondary electrons are detected by the SEM and converted into an image, which is then analyzed to determine whether or not the patterns are correctly formed on the semiconductor substrate.

Unfortunately, SEMs are expensive and they operate very slowly. In addition, it is very difficult to automate inspection methods involving SEMs.

In many cases, a SEM captures multiple images of a semiconductor substrate. The multiple images are generally taken of a single region of the semiconductor substrate and then combined in some fashion to obtain an integrated image of higher quality than each of the individual images. The images may be combined, for example, by averaging them together.

In the conventional method described above, eight (8), sixteen (16), or thirty two (32) images are typically used to form the integrated image. In general, however, any number of images can be used to form the integrated image for the inspection process. In the description that follows, it will be assumed that the number of images used to form an integrated image is an arbitrary natural number “N”.

The following is a description of a conventional method of processing images obtained by a SEM. The images are obtained by irradiating electrons on a semiconductor substrate and then detecting secondary electrons emitted by the semiconductor substrate in response to the irradiated electrons. The detected secondary electrons are converted into electrical signals which are then displayed on a monitor, captured, and stored as an image. The process of capturing and storing an image is repeated “N” times to obtain “N” images of a particular region of the semiconductor substrate.

Because the “N” images are taken of a single region of the semiconductor substrate, pixels at the same location in different images capture roughly the same portion of the semiconductor substrate. As a result, pixels in the same location in different images tend to have substantially the same gray level values. However, in some instances, pixels from the same location in different images may have different gray level values.

In order to form an integrated image from the “N” images, a mean value is obtained for the gray level values of pixels at each pixel location (n,m) in the “N” images. In other words, for each pixel location (n,m), the gray level values of pixels at that location in the multiple images are added up and then divided by “N” to obtain the mean value. The mean value is calculated using following equation (1).

$$F ( n , m ) = {\sum }_{k = 1}^{N} {f}_{k} ( n , m ) \qquad ( 1 )$$

In equation (1), F(n,m) denotes a gray level value of a pixel at a pixel location (n,m) in the integrated image. A variable “n” represents a horizontal coordinate of the pixel location in the integrated image and a variable “m” represents a vertical coordinate of the pixel location in the integrated image. A function fₖ(n,m) indicates a gray level value of a pixel at pixel location (n,m) in each of the images.

FIGS. 1 through 4 are images obtained by a SEM and processed using the conventional image processing method described above. FIG. 1 is an integrated image obtained from one image, FIG. 2 is an integrated image obtained from eight images, FIG. 3 is an integrated image obtained from sixteen images and FIG. 4 is an integrated image obtained from thirty-two images. As shown in FIGS. 1 through 4, increasing the number of images used to form the integrated image tends to improve the clarity of the integrated image.

Since the integrated image obtained using thirty-two images has low noise and a readily measurable critical dimension compared to the integrated image obtained using sixteen (16) images, thirty-two (32) images are generally used to create the integrated image. Unfortunately, obtaining thirty-two images generally requires a significant amount of time, thus increasing the cost of inspecting a semiconductor substrate.

Accordingly, methods of producing high quality images of patterns on a semiconductor substrate without requiring a large number of images are desired.

### SUMMARY OF THE INVENTION

Embodiments of the present invention provide methods of processing images produced by a scanning electron microscope (SEM). The methods produce high quality images in a more efficient manner than conventional image processing methods.

According to one embodiment of the invention, a method comprises obtaining N images of a sample, where N is a number greater than or equal to three (3). The method further comprises computing a sum of data values associated with a pixel location in the N images, wherein the sum omits a maximum data value and a minimum data value from among the data values, dividing the sum by N-2 to obtain a mean data value, and forming an integrated image having the mean data value at the pixel location. The integrated image is typically filtered using a median filter to obtain a filtered integrated image.

According to another embodiment of the present invention, a method of inspecting patterns formed on a semiconductor substrate is provided. The method comprises obtaining N images of the semiconductor substrate, where N is a number greater than or equal to three (3). The method further comprises computing a sum of data values associated with a pixel location in the N images, wherein the sum omits a maximum data value and a minimum data value from among the data values. The method further comprises dividing the sum by N-2 to obtain a mean data value, and forming an integrated image having the mean data value at the pixel location.

According to still another embodiment of the present invention, a method of processing images obtained by a SEM is provided. The method comprises obtaining N images of a semiconductor substrate, computing a sum of data values associated with a pixel location in the N images, wherein the sum omits a maximum data value and a minimum data value from among the data values, dividing the sum by N-2 to obtain a mean data value, and forming an integrated image having the mean data value at the pixel location.

### BRIEF DESCRIPTION OF THE DRAWINGS

The invention is described below in relation to several embodiments illustrated in the accompanying drawings. Throughout the drawings like reference numbers indicate like exemplary elements, components, or steps. In the drawings:

FIGS. 1 through 4 are integrated images formed by combining multiple SEM images using a conventional image processing technique;

FIG. 5 is a flow chart illustrating a method of processing an image in accordance with an embodiment of the present invention;

FIG. 6 is a conceptual diagram of multiple images obtained from a SEM;

FIG. 7 is a conceptual diagram of an integrated image formed by combining multiple images;

FIG. 8 is an image produced by combining multiple SEM images using a conventional method;

FIG. 9 is a graph illustrating a profile of gray level values for the image shown in FIG. 8;

FIG. 10 is an image produced by combining multiple SEM images using the method illustrated in FIG. 5;

FIG. 11 is a graph illustrating a profile of gray level values for the image shown in FIG. 10;

FIG. 12 is a conceptual diagram illustrating a 3×3 median filter used in the method illustrated in FIG. 5;

FIG. 13 is an image created by applying a median filter to the image shown in FIG. 10; and,

FIG. 14 is a graph illustrating a profile of gray level values for the image in FIG. 13.

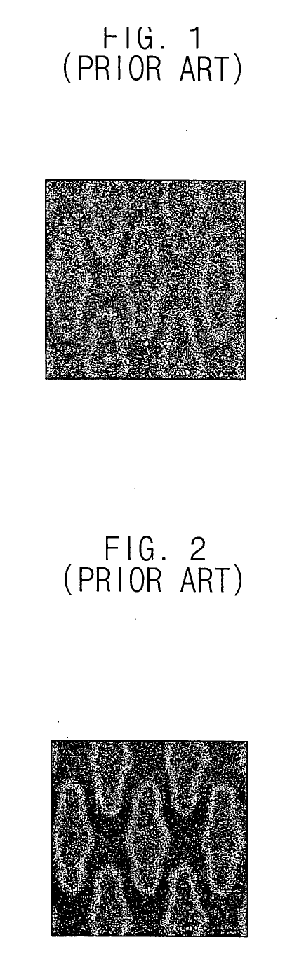

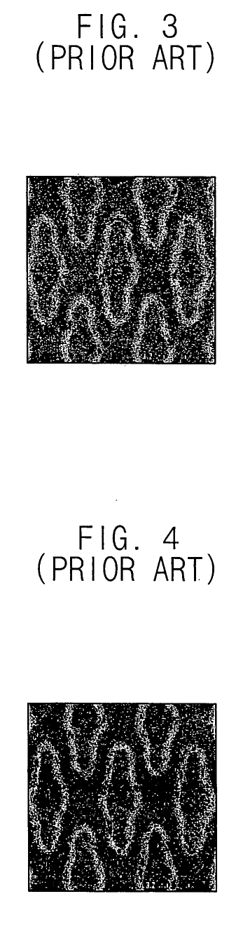

### DESCRIPTION OF THE EXEMPLARY EMBODIMENTS

Exemplary embodiments of the invention are described below with reference to the corresponding drawings. These embodiments are presented as teaching examples. The actual scope of the invention is defined by the claims that follow.

Embodiments of the invention provide image processing methods used to clarify images. The image processing methods are typically applied to images obtained from a SEM, however they could also be used to process images obtained from other image sources.

For purposes of explanation, it will be assumed that the image processing methods are performed by an image processing apparatus comprising a SEM operatively connected to a computer. The SEM comprises an electron source and a detector. The electron source emits focused beams of electrons onto a sample (e.g., a semiconductor substrate) and the detector detects secondary electrons emitted by the sample in response to the focused beams of electrons. The detected secondary electrons are converted into electrical signals, which are then converted into grayscale values, which are displayed on a monitor.

Although the SEM described above uses secondary electrons to produce an image, those skilled in the art will understand that there are various alternative ways of producing an image using a SEM. For example, the SEM may use back-scattered electrons, X-rays, cathode rays, etc. Since secondary electrons have a higher resolving power than other types of electron emissions, secondary electrons are widely used to produce images for semiconductor substrate inspections.

The SEM typically comprises many of the same or analogous elements as an optical microscope. For example, the SEM typically comprises a converging lens and an objective lens. The optical microscope uses visible light and a glass lens and creates images by using refracted light. In contrast, the SEM uses accelerated electron beams and a magnetic lens. The SEM creates images from secondary electrons generated by irradiating electrons on a target. The images are then displayed on a cathode ray tube (CRT) screen. Since the irradiated electrons are readily scattered by foreign substances such as particles in the atmosphere or on the target, the electrons may not be focused with the lens or may not be detected under atmospheric pressure. To avoid this scattering, the electron source, the sample, and the detector are generally enclosed in a vacuum when operating the SEM.

The electron source comprises an electron gun generating and accelerating primary electrons. The electron gun generates the primary electrons using thermionic emission in accordance with Richardson's equation. The electron gun produces enough primary electrons to cause secondary electrons to be emitted from the sample and the magnetic lens converts the primary electrons into small beams focused on small spots on the sample.

The primary electrons are produced by heating a metal cathode filament to a high temperature. The metal cathode filament emits electrons, which are accelerated toward an anode. The metal cathode filament is typically made from a metal such as tungsten or lanthanum hexaboride (LaB₆) and is formed as a linear filament having a diameter of about 100 μm and a bent end with a V shape.

A current is applied to the filament to generate the primary electrons. The current generates a voltage of about 1 to 50 kV across the filament and causes the filament to heat up. The filament has an operating temperature of about 2,700 K and a life span of about 40 to 80 hours under a pressure of about 5 to 10 torr.

Increasing the heat of the filament to increase its electron emission density decreases the life span of the filament. To increase the electron emission density without increasing the heat of the filament, a boron compound having a LaB₆ structure is used for the filament. The boron compound emits many more electrons than tungsten at a temperature of about 1,400 to 2,000 K. Electrons released from the filament are accelerated toward the anode through a hole in an optical axis of the SEM. The anode typically has a potential difference of about 25 to 30 kV relative to the filament.

The magnetic lens is a cylindrical electromagnet on which a coil is wound. The magnetic lens focuses the primary electrons to a point by curving the electrons using a circular magnetic field, which is symmetrical with respect to the optical axis of the SEM. The electrons accelerated in the optical axis tend to follow a spiral path and are then focused.

Electron beams emitted from the electron gun typically have a size of about 10 to 50 μm. In contrast, electron beams emitted from the sample typically have a spot size of about 5 to 200 nm. In other words, the size of electron beams emitted by the sample are about 0.00001 times that of the electron beams generated by the electron gun.

The converging lens focuses the electron beams emitted from the electron gun. Accordingly, the converging lens contributes to the intensity of these electron beams.

The objective lens is used to determine a size of electron beams irradiated onto the sample. The objective lens is commonly referred to as an electron beam-forming lens. The objective lens typically comprises a scanning coil, an aperture, and an aberration coil.

A distance between the objective lens and the sample is referred to as a working distance. Decreasing the working distance leads to a corresponding decrease of the size of electron beams on the sample. Accordingly, high resolution images may be obtained by using a small working distance to finely focus electron beams on the sample.

Where a central axis of the electron gun is not mechanically aligned with a central axis of the condenser lens, electron beams emitted from the electron gun are misaligned with the condenser lens. This causes the resolving power of the condenser lens to be decreased. The central axis of the electron gun is adjusted in an X direction and a Y direction using an electrode coil under the cathode to align the central axis of the electron gun with the central axis of the condenser lens.

The scanning coil is arranged between the condenser lens and the aperture of the objective lens. The scanning coil deflects an electron beam over a surface of the sample in either a linear or raster fashion through a central point of the objective lens. The objective lens magnifies the electron beam at the central point.

After the electron beam collides against the sample, a current is generated in a corresponding point on a cathode ray tube display (CRT) as a result of the collision. The electron beam is preferably irradiated onto the sample in a rectangular shape so that the CRT will display an image having a shape substantially the same as the rectangular shape of the electron beam.

Scattered electrons caused by environmental contaminants may distort the shape of the electron beam and deteriorate the resolution of the SEM. A stigmator uses a current to correct the shape of the electron beam.

The sample is positioned on a metal support that is grounded through a holder. Where electrons irradiated onto the sample are not discharged from the substrate, the non-discharged electrons apply a repulsive force to subsequent electron beams irradiated onto the sample. Because of the repulsive force, the amount of secondary electrons produced by the sample is decreased and the quality of images produced by the SEM decrease.

In order to avoid the decreased image quality caused by non-discharged electrons in the sample, the sample may be sputter coated with carbon or gold-palladium. Sputter coating is also used where the SEM is imaging a non-conductive sample such as certain ceramic materials or some types of molecular compounds.

The holder preferably includes a goniometer that is moved, rotated and tilted in an X-direction, a Y-direction, and a Z-direction. Thus, a wide area of the sample may be observed by moving it to desired positions and directions. A holder for a SEM using energy dispersive spectroscopy (EDS) or for a SEM used for inspecting a semiconductor wafer may include a motor.

Accelerated electrons react with the sample to generate various signals such as secondary electrons and backscattered electrons. Various detectors in the SEM detect the various signals. Since secondary electrons have lower energies than backscattered electrons, the secondary electrons and the backscattered electrons are detected using different detectors. A detector to which a bias of about 125 to 250 V is applied detects the secondary electrons.

A detector for detecting backscattered electrons has a cylindrical shape and is positioned under the objective lens. The primary electrons also react with the sample to generate X-rays and visible light. An energy dispersive X-ray (EDX), a wave dispersive X-ray (WDX), and a cathodoluminescence detector for detecting the X-rays and the visible light are arranged near the sample.

The secondary electrons, the backscattered electrons, the X-rays, and the visible light are converted into analog electric signals and amplified. The amplified analog electric signals are transmitted to the CRT to display an image of the sample on the CRT. Meanwhile, an optical module of a photomultiplier (PMT) is adjusted to control amplification of the image.

The computer connected to the SEM processes data captured by the SEM. In particular, the computer processes images generated by the SEM. An analog to digital converter (ADC) converts the analog image signals output by the detectors in the SEM into digital signals to be processed by the computer as images.

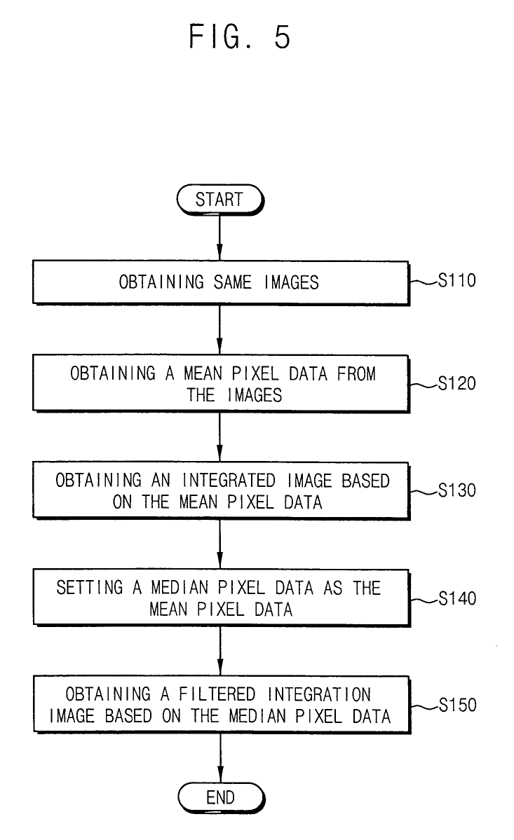

FIG. 5 is a flow chart illustrating a method of processing an image in accordance with an exemplary embodiment of the present invention. In this written description, method steps are designated by parentheses (XXX).

In the method illustrated in FIG. 5, primary electron beams having energy of about 20 to 30 keV are emitted from an electron gun. The primary electron beams are irradiated onto a sample such as, for example, a semiconductor wafer. The irradiated primary electron beams collide against atoms in the sample to emit signals such as secondary electrons, backscattered electrons, X-rays, visible light, and so forth. The signals are detected by corresponding detectors and are then converted into images used to determine various properties of the sample.

An energy spectrum of signals emitted from the semiconductor wafer may be divided into at least two regions. A first region has energy of no more than about 50 eV and a second region has an energy of no more than 100 eV. The intensity of the first region is relatively high compared to the intensity of the second region.

Electrons having energy of no more than 100 eV are referred to as secondary electrons. The secondary electrons are released from atoms in the sample in response to the primary electrons. A detected intensity of the secondary electrons is a function of at least three parameters including the type of atoms in the sample, the shape of the sample, and the position of the detectors. An image obtained from the secondary electrons shows the shape of the sample, e.g., the shape of a semiconductor wafer surface. The SEM mainly uses secondary electrons to form the image.

Electrons scattered from the surface of the wafer are referred to as backscattered electrons. Backscattered electrons have a relatively high intensity compared to secondary electrons. Backscattered electrons are also detected to obtain an image.

Backscattered electrons are scattered proportional to the weights of atoms in the sample. Accordingly, the image obtained from the backscattered electrons displays differences between atomic numbers of atoms in the sample. Thus, the composition of the sample is recognized based on the image obtained from the backscattered electrons. In particular, where the difference between atomic numbers in the sample is at least 20, adjacent compositions are readily distinguished from each other.

Visible light is detected using a Robinson type detector. Fluorescent materials and light-emitting materials are recognized based on an image obtained from the visible light. Elements in the wafer are also detected based on an image obtained from the X-rays. The images obtained from the X-rays and the secondary electrons show a distribution of the elements in the wafer.

Various details related to the operation, construction, and alternative configurations of a SEM have been omitted herein for brevity of explanation. However, those skilled in the art will understand that there are many different ways of obtaining images using a SEM, in addition to those described above.

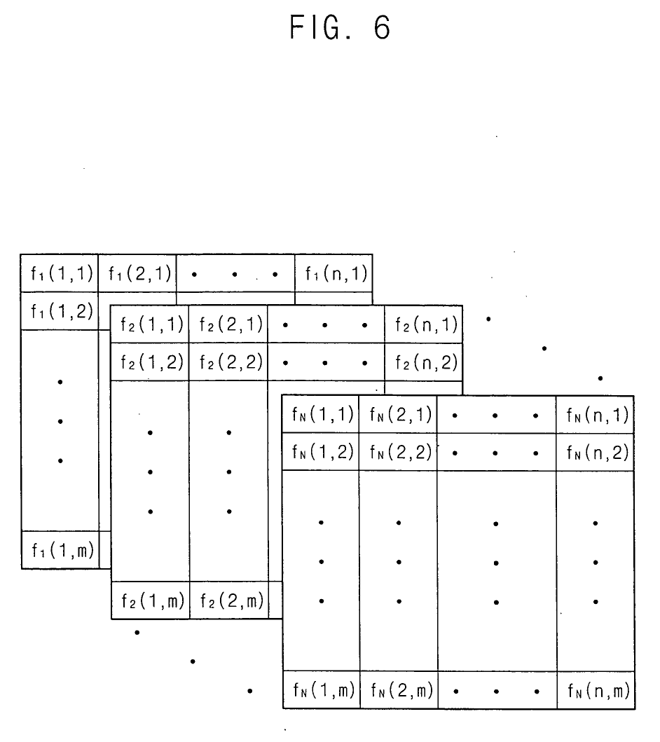

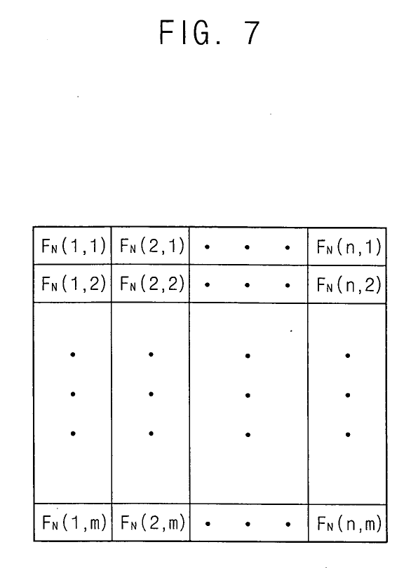

FIG. 6 is a conceptual diagram of “N” images obtained from a SEM and FIG. 7 is a conceptual diagram of an integrated image obtained by integrating the “N” images together.

Referring to FIGS. 5, 6 and 7, signals associated with secondary electrons emitted by the sample are displayed on a CRT screen to obtain an image. This process is repeated “N” times to obtain “N” images (SI 10) of a region of the sample. “N” typically ranges between 3 and 32. Preferably, “N” is equal to 16.

Each of the “N” images has substantially same number of pixels. For explanation purposes, it will be assumed that each image has “n” rows and “m” columns of pixels. Thus, each of the “N” images has “n”×“m” pixels. In addition, each of the pixels has substantially the same size.

Each of the “n”×“m” pixels in the “N” images is characterized by a gray level value. Since the images are obtained from the same region of the sample, the gray level values associated with pixels of the same location in each image tend to be substantially the same.

For each location in the “N” images, a sum of the gray levels of pixels at that location is calculated. For example, as shown in FIG. 6, let the gray level value of a pixel at a pixel location (n,m) in the “i^{th}” image be denoted as fᵢ(x,y). The sum “S” of the gray levels for pixel location (n,m) is calculated with the equation

$$S = {\sum }_{i = 1}^{N} {f}_{i} ( n , m ) .$$

Preferably, the maximum and minimum gray level values for each location are omitted from the sum. However, in cases where “N” is less than 4, the minimum and maximum gray level values are generally not omitted. In addition, where more than one pixel has the maximum or minimum gray level value, the maximum or minimum gray level value is only omitted from the sum once.

Sum “S” is divided by the number of values used to compute “S” (generally “N-2”) to obtain a mean gray level value F(n,m) for each pixel location in the “N” images (S120). The mean gray level level F(n,m) is computed by the following equation (2).

$$F ( n , m ) = \frac{{\sum }_{k = 1}^{N} {f}_{k} ( n , m ) - [ max {f}_{( 1 - N )} ( n , m ) + min {f}_{( 1 - N )} ( n , m ) ]}{N - 2} \qquad ( 2 )$$

In Equation 2, F(n,m) indicates a gray level value of a pixel at a pixel location (n,m) in an integrated image formed by combining “N” images. The function fₖ(n,m) denotes a gray level value of the pixel at pixel location (n,m) in an image k. max(f_{(1˜N)}(n,m)) indicates the maximum gray level value of pixels at pixel location (n,m) and min(f_{(1˜N)}(n,m)) indicates the minimum gray level value in the “N” images. (N-2) represents the number of the pixels used to compute the mean.

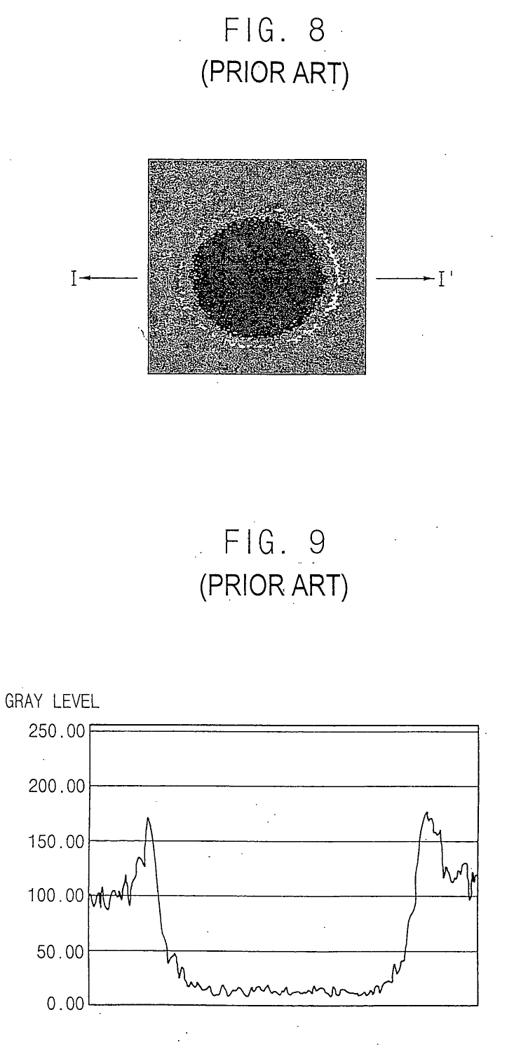

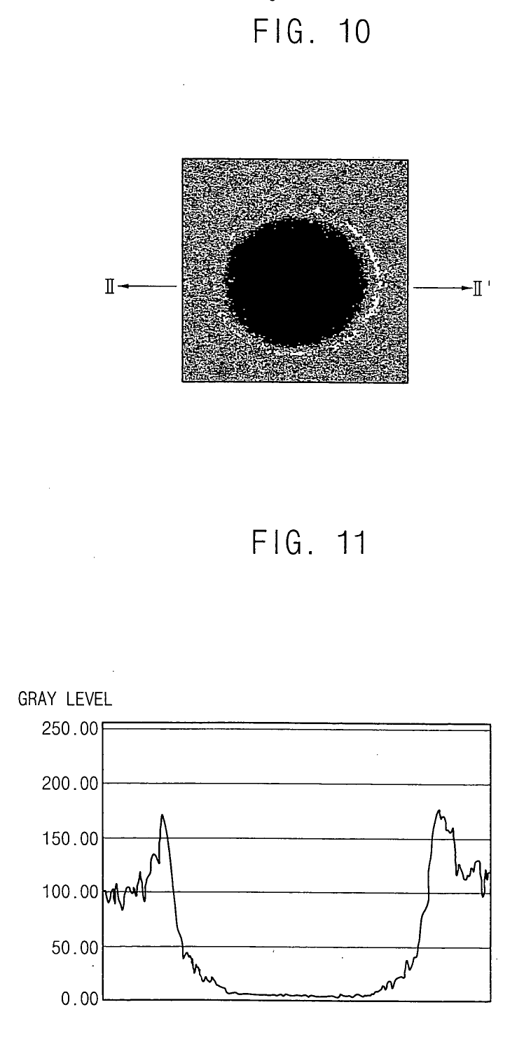

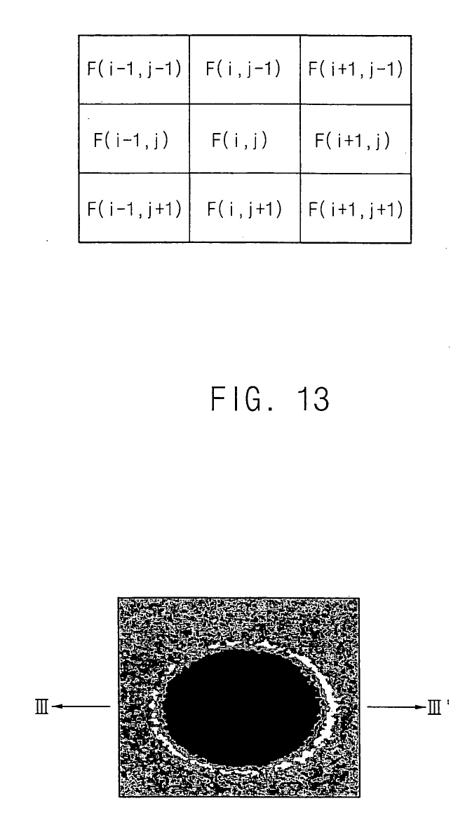

The integrated image is formed by the mean gray level values computed for each pixel location (n,m) in the “N” images (S130). FIG. 8 is a picture illustrating a SEM image formed by combining 32 images according to a conventional method. FIG. 9 is a graph illustrating a profile of gray level values for the SEM image of FIG. 8. FIG. 10 is a picture illustrating an integrated image formed by combining 16 images according to the method illustrated in FIG. 5. FIG. 11 is a graph illustrating a profile of gray level values for the integrated image in FIG. 10.

Referring to FIGS. 8 and 10, the integrated image obtained using the method described in relation to FIG. 5 has relatively low noise and a relatively high resolution compared to that obtained using the conventional method. Thus, it shall be noted that a CD of a semiconductor wafer may be measured using the integrated image obtained from the method illustrated in FIG. 5.

Referring to FIGS. 9 and 11, the profile of the integrated image obtained by the method of FIG. 5 is at least as useful for measuring a CD of a semiconductor wafer as profile of the integrated image obtained using the conventional method.

In sum, by omitting pixels with minimum and maximum gray level values from the computation of a mean pixel value, a clear image can be obtained for a semiconductor inspection using only 16 images.

FIG. 12 is a conceptual diagram of a 3×3 median filter used in the method described in relation to FIG. 5. In general, a median filter processes an image by replacing a gray level value at a particular pixel location with a median gray level value of a collection of pixels at and around the particular pixel location (S140). For example, referring to FIG. 12, gray level value F(n,m) is replaced by a median gray level value taken among nine (9) gray level values corresponding to pixel location (i,j) and its surrounding pixels.

More specifically, in FIG. 12, the gray level value of a center pixel in the 3×3 median filter is represented as F(i,j). Eight peripheral pixels are arranged around the center pixel, making nine (9) pixels total. The gray level values of the peripheral pixels are represented as F(i−1,j−1), F(i,j−1), F(i+1,j−1), F(i−1,j), F(i+1,j), F(i−1,j+1), F(i,j+1) and F(i+1,j+1), respectively. The gray level value of the center pixel is replaced with the median gray level value taken from among gray level values corresponding to the nine (9) pixels. This is represented by the following equation (3).
Fₘ(i,j)=Median[F(i−1 j−1)˜F(i+1,j+1)] (3)

In equation (3), Fₘ(i,j) indicates a gray level value at a pixel location (i,j) to which the median filter is applied.

Where the 3×3 median filter is applied to a pixel located at an edge of an image, only five peripheral pixels are arranged around the center pixel. Accordingly, six gray level values are used in the median filter.

Where the 3×3 median filter is applied to a pixel located at a corner of an image, three peripheral pixels are arranged around the center pixel. Accordingly, four gray level values are used in the median filter.

Various modifications may be made to the median filter. For instance, the size of the median filter may be larger than 3×3 and the shape of the median filter does not necessarily have to be a complete square. In addition, the center pixel or some of the peripheral pixels could be ignored in computing the median with the median filter.

Filtering an image with a median filter tends to remove noise from the image and enhance contrast between light and dark regions of the image. The median filtering method effectively removes impulse, and salt and pepper noise.

The gray level values obtained by applying the median filter to the image are used to form an integrated image (S150).

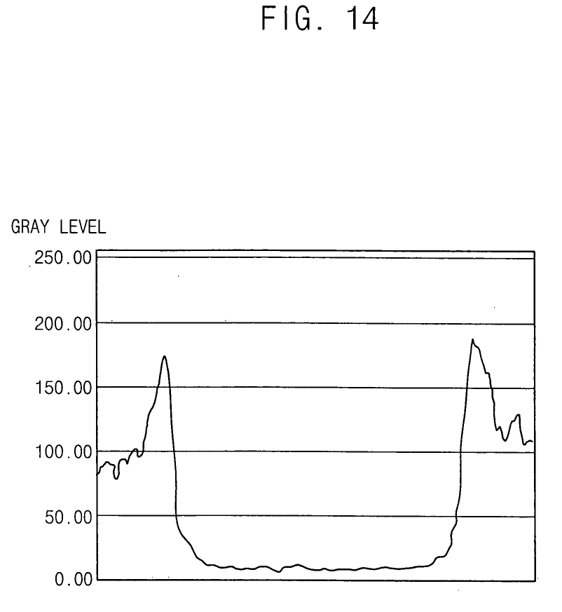

FIG. 13 is a SEM image created by filtering the integrated image in FIG. 10 with a 3×3 median filter and FIG. 14 is a graph illustrating a profile of gray level values for the SEM image in FIG. 13.

The image shown in FIG. 13 has low noise and good contrast compared to the image in FIG. 10 and the profile shown in FIG. 14 is more pronounced than the profile shown in FIG. 11.

In sum, embodiments of the invention described above provide methods for processing images produced by a SEM. The methods reduce noise in the images and they increase the sharpness of the images, thus allowing the images to be used for inspecting fine patterns formed on a semiconductor substrate.

Because the methods rely on a reduced number of images relative to conventional methods, they tend to take less time, and hence, are less expensive than the conventional methods.

The foregoing preferred embodiments are teaching examples. Those of ordinary skill in the art will understand that various changes in form and details may be made to the exemplary embodiments without departing from the scope of the present invention which is defined by the following claims.

What is claimed is:

1. A method, comprising:
obtaining N images of a sample, where N is a number greater than or equal to three (3);
computing a sum of data values associated with a pixel location in the N images, wherein the sum omits a maximum data value and a minimum data value from among the data values;
dividing the sum by (N-2) to obtain a mean data value; and,
forming an integrated image having the mean data value at the pixel location.

2. The method of claim 1, further comprising:
filtering the integrated image.

3. The method of claim 2, wherein filtering the integrated image comprises:
computing a median data value from at least three mean data values at or adjacent to the pixel location; and,
forming a filtered integrated image having the median data value at the pixel location.

4. The method of claim 3, wherein the median data value is computed from nine (9) mean data values at pixel locations defined by a 3×3 grid centered at the pixel location.

5. The method of claim 1, wherein the data values associated with the pixel location comprise gray level values.

6. The method of claim 1, wherein the N images are obtained using a scanning electron microscope (SEM).

7. The method of claim 1, wherein the sample comprises a semiconductor substrate on which a pattern is formed.

8. The method of claim 1, wherein N equals sixteen (16).

9. A method of inspecting patterns formed on a semiconductor substrate, the method comprising:
obtaining N images of the semiconductor substrate, where N is a number greater than or equal to three (3);
computing a sum of data values associated with a pixel location in the N images, wherein the sum omits a maximum data value and a minimum data value from among the data values;
dividing the sum by (N−2) to obtain a mean data value; and,
forming an integrated image having the mean data value at the pixel location.

10. The method of claim 9, further comprising:
filtering the integrated image.

11. The method of claim 9, wherein the data values associated with the pixel location comprise gray level values.

12. The method of claim 10, wherein filtering the integrated image comprises:
computing a median data value from at least three mean data values at or adjacent to the pixel location; and,
forming a filtered integrated image having the median data value at the pixel location.

13. The method of claim 12, wherein the median data value is computed from nine (9) mean data values at pixel locations defined by a 3×3 grid centered at the pixel location.

14. The method of claim 1, wherein the N images are obtained using a scanning electron microscope (SEM).

15. A method of processing images obtained by a scanning electron microscope (SEM), the method comprising:
obtaining N images of a semiconductor substrate, where N is a number greater than or equal to three (3);
computing a sum of data values associated with a pixel location in the N images, wherein the sum omits a maximum data value and a minimum data value from among the data values;
dividing the sum by N−2 to obtain a mean data value; and,
forming an integrated image having the mean data value at the pixel location.

16. The method of claim 15, wherein the mean data value is obtained by a computer operatively connected to the SEM.

17. The method of claim 16, further comprising:
filtering the integrated image.

18. The method of claim 15, wherein the data values associated with the pixel location comprise gray level values.

19. The method of claim 17, wherein filtering the integrated image comprises:
computing a median data value from at least three mean data values at or adjacent to the pixel location; and,
forming a filtered integrated image having the median data value at the pixel location.

20. The method of claim 19, wherein the median data value is computed from nine (9) mean data values at pixel locations defined by a 3×3 grid centered at the pixel location.
